(19) United States
(12) Patent Application Publication
(10) Pub. No.: US 2013/0229820 A1
(43) Pub. Date: Sep. 5, 2013

(54) VEHICLE BODY SIDE LIGHTING

(71) Applicants: Brian J. Jutila, Richmond, MI (US); Jeffrey A. Diegel, South Lyon, MI (US); Joel T. Bachler, Rochester, MI (US); Paul R. Dynes, Bloomfield, MI (US); Robert Dallos, JR., Canton, MI (US)

(72) Inventors: Brian J. Jutila, Richmond, MI (US); Jeffrey A. Diegel, South Lyon, MI (US); Joel T. Bachler, Rochester, MI (US); Paul R. Dynes, Bloomfield, MI (US); Robert Dallos, JR., Canton, MI (US)

(73) Assignee: GM GLOBAL TECHNOLOGY OPERATIONS LLC, Detroit, MI (US)

(21) Appl. No.: 13/409,501

(22) Filed: Mar. 1, 2012

(51) Int. Cl. F21S 8/10

(52) U.S. Cl. 362/545

(57) ABSTRACT

A lighting system for an exterior panel of a vehicle includes a molding configured to be affixed to the exterior panel. The molding includes a feature configured to retain a light string and fix the light string relative to the molding. The light string is configured to be connected to an electric system of the vehicle and be activated to illuminate an area surrounding the exterior panel is illuminated. A vehicle employing the lighting system is also disclosed.

### TECHNICAL FIELD

The present disclosure relates to a lighting system integrated into a body side of a vehicle.

### BACKGROUND

Vehicles are frequently equipped with exterior lighting systems for the purpose of illuminating the road ahead during periods of low visibility, such as darkness or precipitation.

Generally, vehicle exterior lighting is also intended to permit the subject vehicle to be seen from surrounding areas, for example by operators of other, approaching vehicles. Vehicle exterior lighting may also be used to assist vehicle occupants with identifying their vehicle, for example on approach to the vehicle in a crowded parking lot.

### SUMMARY

A lighting system for an exterior panel of a vehicle includes a molding configured to be affixed to the exterior panel. The molding includes a feature configured to retain a light string and fix the light string relative to the molding. The light string is configured to be connected to an electric system of the vehicle and activated to illuminate an area surrounding the exterior panel.

The electric system may include an energy storage device. The light string may include a fiber optic element in operative communication with at least one light-emitting diode (LED). The at least one LED may be energized by the energy storage device to generate the light. The light may be transmitted through and emitted by the fiber optic element to illuminate the area surrounding the exterior panel.

The fiber optic element may include a first end and a second end and the at least one LED may include a first LED and a second LED. In such a case, the first LED may be in operative communication with the first end of the fiber optic element and the second LED may be in operative communication with the second end of the fiber optic element.

The feature may be configured as a channel formed in the molding. The fiber optic element may then be captured by the channel. The feature may also be a lip formed in the molding and configured to retain the fiber optic element against the exterior panel after the molding is attached to the exterior panel.

The lighting system may additionally include a controller configured to activate the light string. The controller may be at least one of a vehicle body controller and a remote key fob. The fob may be configured to activate the light string automatically, based on proximity to the vehicle, or manually by an operator thereof on approach to the vehicle.

The light generated by the light string may have a selectively variable intensity or a plurality of brightness levels that is regulated by the controller.

The exterior panel may be a vehicle door or a vehicle rocker panel. Additionally, the light string may be activated automatically when the door is unlocked.

A vehicle employing the system is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic perspective illustration of a motor vehicle having a lighting system incorporated into exterior panels of the vehicle according to the disclosure.

FIG. 2 is a schematic perspective illustration of the lighting system shown in FIG. 1 according to one embodiment and depicting a light string having light-emitting diodes (LEDs) connected to a fiber optic element.

FIG. 3 is a schematic perspective illustration of the lighting system shown in FIG. 1 according to another embodiment and depicting the light string having LEDs connected to the fiber optic element.

### DETAILED DESCRIPTION

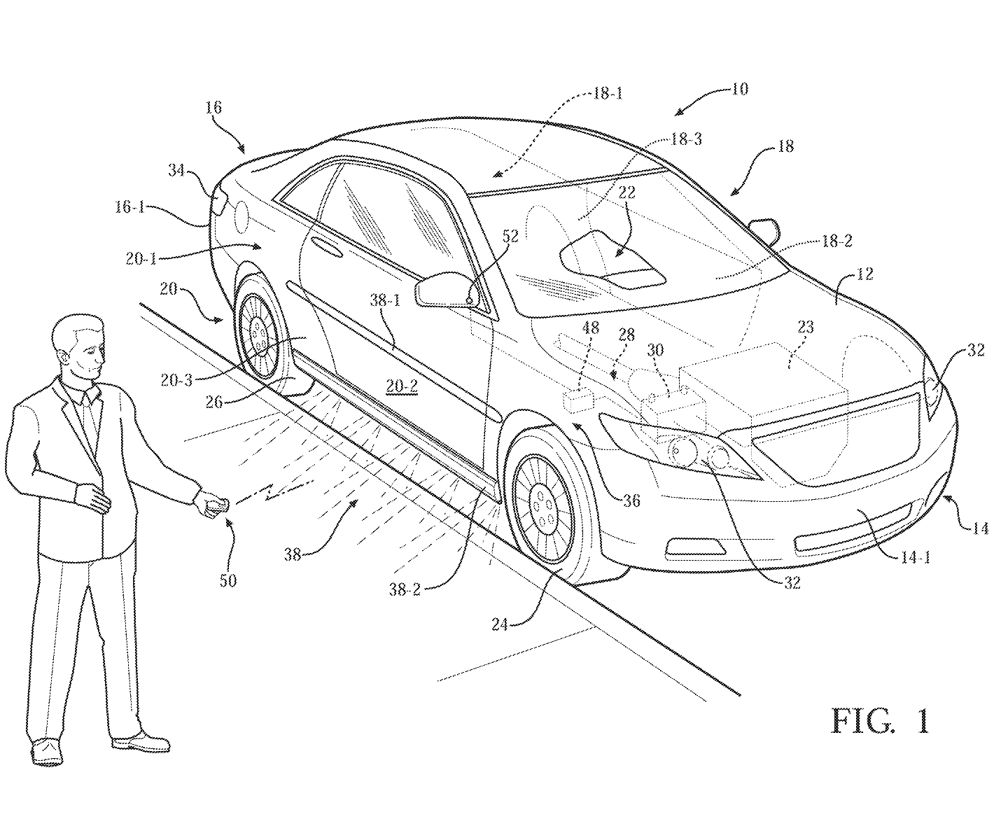

Referring to the drawings, wherein like reference numbers refer to like components, FIG. 1 shows a schematic view of a motor vehicle 10 which includes a vehicle body 12. The vehicle body 12 additionally includes exterior panels positioned at a front end 14, at a rear end 16, as well as at a left body side 18 and at a right body side 20. As shown in FIG. 1, the exterior panel 14-1 is positioned at the front end 14, the exterior panel 16-1 is positioned at the rear end 16, the exterior panel 18-1 is positioned at the left body side 18, and the exterior panel 20-1 is positioned at the right body side 20. The exterior panel 18-1 may include at least one left side door 18-2 and also a left side rocker panel 18-3. Similarly, the exterior panel 20-1 may include at least one right side door 20-2 and also a right side rocker panel 20-3. Although one door is shown in FIG. 1 on each of the exterior panels 18-1 and 20-1, each exterior panel may include any number of doors, as needed.

The vehicle 10 also includes an interior 22 configured to accommodate a vehicle operator and passenger(s). The vehicle 10 additionally includes a powertrain 23 configured to propel the vehicle via front wheels 24, rear wheels 26, or via all four wheels 24 and 26. Furthermore, the vehicle 10 includes an electric system 28 having an energy storage device 30, such as one or more batteries, configured to accept electric charge. The electric system 28 is configured to supply electric current to operate various vehicle systems, such as vehicle head lamps 32, tail lamps 34, a heating, ventilation, and air conditioning (HVAC) system, and a vehicle infotainment system (neither of which are shown, but known to those skilled in the art).

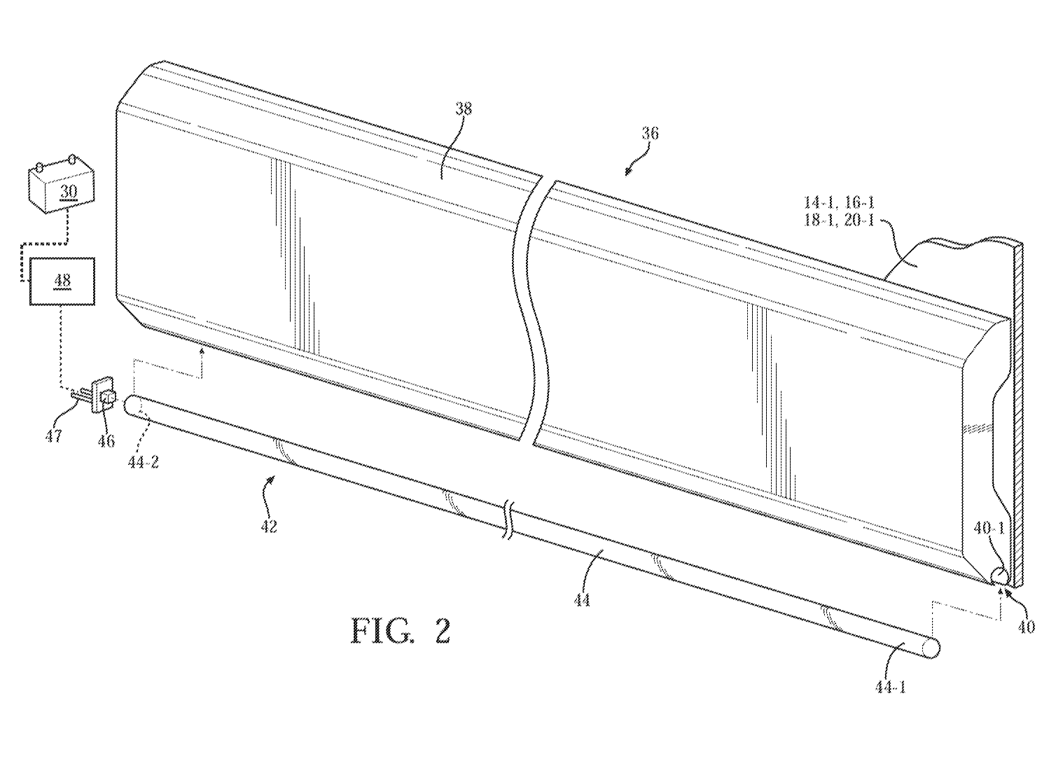

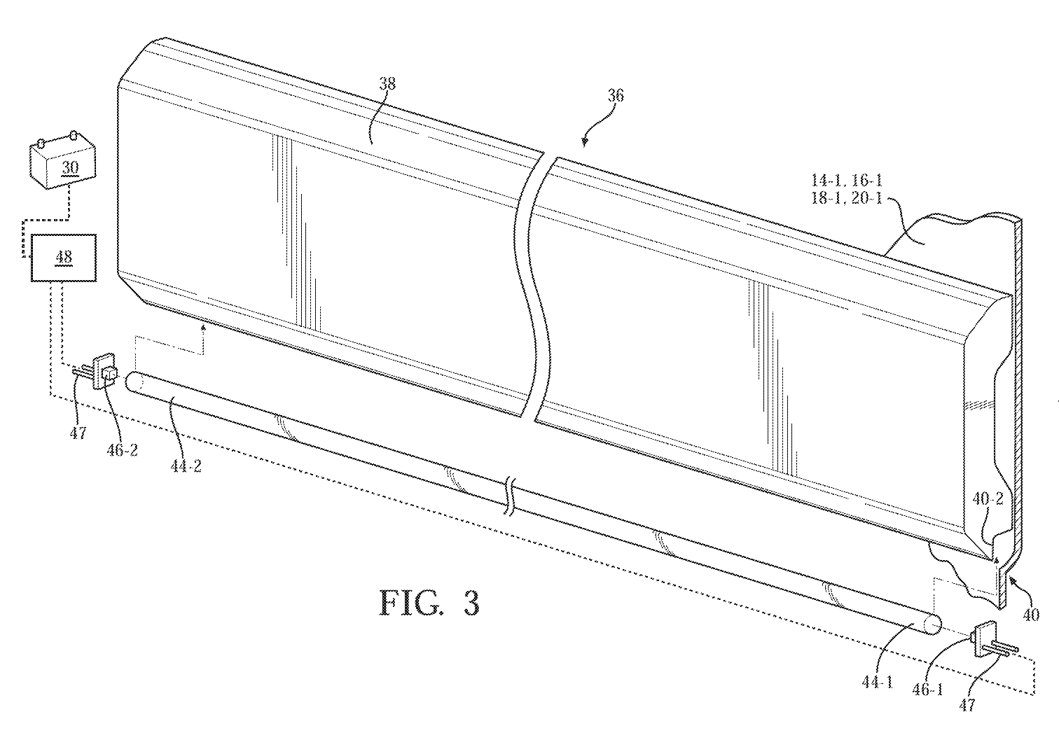

With continued reference to FIG. 1, the vehicle 10 also includes a lighting system 36. The lighting system 36 includes a molding 38. The molding 38 may be affixed to any of the exterior panels 14-1, 16-1, 18-1, and 20-1. As shown, the molding 38 may be specifically configured as a molding 38-1 that is affixed to the left or right side door 18-2 or 20-2, respectively, and as a molding 38-2 that is affixed to the left or right side rocker panel 18-3 or 20-3, respectively. The molding 38 may be formed, for example injection molded, from a polymeric material. As shown in FIGS. 2 and 3, the molding 38 may include a feature 40. The feature 40 may be integrally formed into the molding 38. The lighting system 36 also includes a light string 42 retained by the feature 40 and fixed relative to the molding 38. The light string 42 is in electric communication with the electric system 28 to receive electric current from the energy storage device 30. The light string 42 is configured to be activated in order to generate and emit an amount of light sufficient to illuminate an area surrounding the respective exterior panel.

As shown in FIG. 2, the light string 42 may include a fiber optic element 44. The fiber optic element 44 is a flexible, transparent fiber made of a pure glass, or from an acrylic or urethane material. The fiber optic element 44 functions as a waveguide or light pipe to transmit light between two ends of the fiber, a first end 44-1 and a second end 44-2. The fiber optic element 44 may include a plurality of fibers wrapped in a bundle. The fiber optic element 44 is connected to and in operative communication with at least one light-emitting diode (LED) 46 via suitable connection such as via a snap-in arrangement. With respect to present disclosure, operative connection and communication between the LED 46 and the fiber optic element 44 is of the type that permits waves of light emitted by the LED to be directed into the fiber optic element and transmitted there through. The LED 46 is a semiconductor light source that may be forward biased or activated to release energy and thus produce electroluminescence characterized by high brightness. The at least one LED 46 is electrically connected to the energy storage device 30 via a connector 47 and is energized by the energy storage device to generate the aforementioned light. The light from the LED 46 is subsequently transmitted through and emitted by the fiber optic element 44 to illuminate the area surrounding the subject exterior panel 14-1, 16-1, 18-1, or 20-1.

As shown in FIG. 3, the at least one LED 46 may include a pair of LEDs: a first LED 46-1 and a second LED 46-2. The first LED 46-1 is in operative communication with the first end 44-1 of the fiber optic element 44 while the second LED 46-2 is in operative communication with the second end 44-2 of the fiber optic element. Although a single LED 46 (shown in FIG. 2) may be sufficient to generate an adequate amount of light to illuminate the area surrounding the subject exterior panel, a pair of LEDs—the first LED 46-1 and the second LED 46-2 may provide a more uniform or consistent light distribution by passing light from opposite ends, 44-1 and 44-2, of the fiber optic element 44.

As shown in FIG. 2, the feature 40 may be configured as a channel 40-1 formed in the molding 38. In such a case, the fiber optic element 44 is captured by or snapped into the channel 40-1. As shown in FIG. 3, the feature 40 may be configured as a lip 40-2 formed in the molding 38. In such an alternative case, the lip 40-2 is configured to retain the fiber optic element 44 against the exterior panel 14-1, 16-1, 18-1, or 20-1 after the molding 38 is attached to the subject exterior panel.

Referring back to FIG. 1, the vehicle 10 also includes a body controller 48. The body controller 48 may be configured to regulate operation of the electric system 28, along with functions such as locking and unlocking of the vehicle doors 18-2, 20-2, turning on and off head lamps 32 and tail lamps 34, etc. The body controller 48 may also be configured to activate the light string 42 automatically in response to occurrence of certain conditions programmed into the controller. Such conditions may include the vehicle 10 coming to a stop, the powertrain 23 being turned off, and/or at least one of the doors 18-2, 20-2 being opened. Illumination of areas surrounding the vehicle and particularly the areas near exterior panels 14-1, 16-1, 18-1, and 20-1 is particularly beneficial to permit more effective assessment of the ground surface near the vehicle 10 for the vehicle occupant(s) during ingress/egress from the vehicle. Furthermore, additional illumination provided by the activated lighting system 36 is especially convenient and beneficial during times of reduced visibility, such as at dusk and during inclement weather.

As additionally shown in FIG. 1, the vehicle 10 may also include a remote controller such as a key fob 50. The fob 50 may be used to activate the light string 42 based on the fob's proximity to the vehicle 10, or manually by an operator of the fob on approach to the subject vehicle. In such a case, the body controller 48 may be programmed to detect entry of the fob 50 into a predetermined area surrounding the vehicle 10 and to automatically activate the light string 42 on any of the particular moldings 38 or on all the moldings at once.

The light generated by the light string 42 may have a selectively variable intensity or a plurality of brightness levels. The light intensity of the light string 42 may be regulated by the body controller 48. Accordingly, the LED 46, or LEDs 46-1 and 46-2, may be regulated by the body controller 48 to generate a light of varied intensity in response to the occurrence of pre-programmed conditions, such as level of ambient lighting sensed via a sensor 52. In the situation where the exterior panel is a vehicle door 18-2 or 20-2, the specific light strings 42 incorporated into the moldings 38 may be selectively activated by the body controller 48 based on which door is being unlocked or opened. Accordingly, the light string 42 may be activated automatically by the body controller 48 when the body controller has detected that a particular door 18-2 or 20-2 has been unlocked.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A vehicle comprising:
a vehicle body having an exterior panel;
a vehicle electric system; and
a lighting system including:
a molding affixed to the exterior panel and having a feature; and
a light string retained by the feature and fixed relative to the molding;
wherein the light string is in electric communication with the electric system and configured to be activated to illuminate an area surrounding the exterior panel.

2. The vehicle of claim 1, wherein:
the light string includes a fiber optic element in operative communication with at least one light-emitting diode (LED);
the at least one LED is energized by the electric system to generate the light; and
the light is transmitted through and emitted by the fiber optic element to illuminate the area surrounding the exterior panel.

3. The vehicle of claim 2, wherein:
the fiber optic element includes a first end and a second end;
the at least one LED includes a first LED and a second LED; and
the first LED is in operative communication with the first end of the fiber optic element and the second LED is in operative communication with the second end of the fiber optic element.

4. The vehicle of claim 2, wherein the feature is a channel formed in the molding and the fiber optic element is captured by the channel.

5. The vehicle of claim 2, wherein the feature is a lip formed in the molding and configured to retain the fiber optic element against the exterior panel after the molding is attached to the exterior panel.

6. The vehicle of claim 1, wherein:
the light string is configured to be activated by a controller; and
the controller is at least one of a vehicle body controller and a remote key fob.

7. The vehicle of claim 6, wherein the light generated by the light string has a selectively variable intensity that is regulated by the controller.

8. The vehicle of claim 1, wherein the exterior panel is one of a vehicle door and a vehicle rocker panel.

9. The vehicle of claim 8, wherein the light string is activated automatically when the door is unlocked.

10. A lighting system for an exterior panel of a vehicle, the lighting system comprising:
a molding configured to be affixed to the exterior panel and having a feature; and
a light string retained by the feature and fixed relative to the molding;
wherein the light string is configured to be connected to an electric system of the vehicle and be activated to illuminate an area surrounding the exterior panel.

11. The lighting system of claim 10, wherein:
the electric system includes an energy storage device;
the light string includes a fiber optic element in operative communication with at least one light-emitting diode (LED);
the at least one LED is energized by the energy storage device to generate the light; and
the light is transmitted through and emitted by the fiber optic element to illuminate the area surrounding the exterior panel.

12. The lighting system of claim 11, wherein:
the fiber optic element includes a first end and a second end;
the at least one LED includes a first LED and a second LED; and
the first LED is in operative communication with the first end of the fiber optic element and the second LED is in operative communication with the second end of the fiber optic element.

13. The lighting system of claim 11, wherein the feature is a channel formed in the molding and the fiber optic element is captured by the channel.

14. The lighting system of claim 11, wherein the feature is a lip formed in the molding and configured to retain the fiber optic element against the exterior panel after the molding is attached to the exterior panel.

15. The lighting system of claim 10, further comprising a controller configured to activate the light string, wherein the controller is at least one of a vehicle body controller and a remote key fob.

16. The lighting system of claim 10, wherein the light generated by the light string has a selectively variable intensity that is regulated by the controller.

17. The lighting system of claim 10, wherein the exterior panel is one of a vehicle door and a vehicle rocker panel.

18. The lighting system of claim 17, wherein the light string is activated automatically when the door is unlocked.

19. A lighting system for an exterior panel of a vehicle, the lighting system comprising:
a molding configured to be affixed to the exterior panel and having a feature; and
a light string retained by the feature and fixed relative to the molding;
wherein:
the light string is configured to be connected to an electric system of the vehicle and be activated to illuminate an area surrounding the exterior panel;
the electric system includes an energy storage device;
the light string includes a fiber optic element in operative communication with at least one light-emitting diode (LED);
the at least one LED is energized by the energy storage device to generate the light; and
the light is transmitted through and emitted by the fiber optic element to illuminate the area surrounding the exterior panel.

20. The lighting system of claim 19, further comprising a controller configured to activate the light string;
wherein:
the fiber optic element includes a first end and a second end;
the at least one LED includes a first LED and a second LED; and
the first LED is in operative communication with the first end of the fiber optic element and the second LED is in operative communication with the second end of the fiber optic element;
the controller is at least one of a vehicle body controller and a remote key fob; and
the light generated by the light string has a selectively variable intensity that is regulated by the controller.
